(19) United States
(12) Patent Application Publication
(10) Pub. No.: US 2009/0195470 A1
(43) Pub. Date: Aug. 6, 2009

(54) WIDE-BAND ANTENNA

(75) Inventors: Tetsuro Tsurusu, Kusatsu-shi (JP); Shinji Hashiyama, Otsu-shi (JP); Takeshi Hama, Koga-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi (JP)

(21) Appl. No.: 12/061,811

(22) Filed: Apr. 3, 2008

(30) Foreign Application Priority Data
Apr. 11, 2007 (JP) 2007-104248

(51) Int. Cl. H01Q 9/28

(52) U.S. Cl. 343/807

(57) ABSTRACT

A wide-band antenna includes radiation devices and an electric supply line. The radiation devices include a first radiation device and a second radiation device. The electric supply line includes a coaxial cable. The first and the second radiation devices are conductor members placed opposite to each other across an electric supply point. The conductor members are line-symmetrical with respect to a straight line passing through the electric supply line. The first radiation device is connected to an inner core of the electric supply line. The second radiation device is connected to an outer conductor of the electric supply line. A conductor member including two electrode portions is connected to the second radiation device. The two electrode portions are placed such that a longitudinal axis thereof is parallel to the electric supply line and is line-symmetrical with respect to the straight line passing through the electric supply line.

### BACKGROUND OF THE INVENTION

1. Field of the Invention

The present invention relates to a wide-band antenna for use in a communication system such as a Broadband-PAN (Personal Area Network) which utilizes UWB (Ultra Wide Band) techniques.

2. Description of the Related Art

There is a need for antennas capable of preventing the antenna gain from changing with respect to the frequency, as antennas for use in broadband communications such as UWB. This is because of the following reason. The maximum value of the electromagnetic power which is allowed to be radiated from a communication apparatus is specified by the radio law and, accordingly, a communication apparatus is designed in conformance to the maximum value of the antenna gain within the usage frequency band. Accordingly, in cases of communication using frequencies within a wide frequency band (3.1 GHz to 4.9 GHz), the communication distance is determined by the minimum value of the antenna gain within the usage frequency band. Namely, in cases where the antenna gain significantly varies with respect to the frequency, there is the problem of reduction of the communication distance.

For example, FIG. 19 exemplifies the relationships between the frequency and the antenna gain of two types of antennas A and B. In the usage frequency band, the maximum antenna gain values of the antennas A and B are substantially equal. However, regarding the minimum antenna gain values within the usage frequency band, the minimum gain value of the antenna A is not significantly different from the maximum gain value thereof and, thus, a substantially uniform antenna gain is obtained within the usage frequency band, but the minimum gain value of the antenna B is significantly smaller than the maximum gain value thereof. Accordingly, the communication distance of the antenna B is limited by the minimum gain value which is significantly smaller than the maximum gain value, and it can be said that the antenna B is not suitable for wide-band communication.

Further, generally, a UWB communication apparatus is expected to be used indoors and, therefore, the wide-band antenna (UWB antenna) for use with the UWB communication apparatus is preferably capable of communication, regardless of the indoor position at which its transmission/reception device is placed. Accordingly, the UWB antenna desirably has omni-directionality, in order to radiate the same electric power, in every direction, out of a horizontal in-plane direction (in an XY in-plane direction in FIG. 20), as illustrated in FIG. 20. Further, there are possibly cases where the transmitting device and the receiving device are installed at different heights and, accordingly, the UWB antenna preferably has omni-directionality in a certain vertical in-plain direction.

Most of electronic apparatuses have been required to have reduced sizes, and the communication apparatuses are no exception. Further, in cases of reducing the sizes of wide-band antennas, there is the problem of degradation of their omni-directionality due to the leak electric current flowing to electric supply lines. This problem will be described in more detail, hereinafter.

Generally, an antenna is structured to include radiation devices and an electric supply line for supplying electric signals to the radiation devices. The electric supply line of the antenna is constituted by a coaxial cable and, when signal radio waves are radiated from the antenna, a leak electric current is generated from an electric supply point to the outer conductor of the coaxial cable. Further, this leak electric current induces an electromagnetic field around the coaxial cable, and the electromagnetic field induced by the leak electric current draws, thereinto, the signal radio waves radiated from the radiation devices. Usually, the electric supply line of an antenna exists below the lower portions of the radiation devices and, in this case, signal radio waves radiated from the radiation devices have high intensities in a downward direction while having lower intensities in an upward direction, thereby degrading the omni-directionality particularly in a vertical in-plain direction. For example, in cases where the receiving antenna is placed at a position higher than the transmission antenna, there is the possibility of degradation of the signal reception condition.

The adverse influence of the leak electric current on omni-directionality becomes more prominent as a diameter of the electric supply line is increased with respect to the radiation devices. Namely, the adverse influence thereof becomes more prominent as the size of the radiation devices is reduced for reducing the size of the antenna.

Japanese Unexamined Patent Application Publication No. 2005-12841 (published on Jan. 13, 2005) discloses a technique for attenuating the leak electric current flowing through an electric supply line using a resistance, in an unbalanced antenna including radiation conductors, a ground conductor and the electric supply line, by covering a portion of the electric supply line with an electric-current absorption member and causing the ground conductor to have a lower conductivity at a portion of its end portion.

Further, Japanese Patent Application Laid-Open Publication No. 10-233619 (published on Sep. 2, 1998) discloses a technique for canceling a leak electric current using a reflected wave, by mounting, to an electric supply line, a reflection device having a length equal to one fourth of the used wavelength λ.

However, the technique of the Japanese Unexamined Patent Application Publication No. 2005-12841 attenuates the leak electric current with a resistance, which reduces the antenna gain in the horizontal in-plane direction, thereby inducing the problem of increase of the maximum-to-minimum antenna gain width within the usage frequency band.

Further, the technique of the Japanese Patent Application Laid-Open Publication No. 10-233619 functions only within a narrow band and, in cases of wide-band systems such as UWB, the technique can not prevent the leak electric current at all frequencies within the usage frequency band, thereby inducing the problem of increase of the maximum-to-minimum antenna gain width within the usage frequency band.

### SUMMARY OF THE INVENTION

The present invention was made in view of the aforementioned problem and aims at realizing a wide-band antenna capable of reducing the leak electric current flowing through the electric supply line over a wide band, thereby suppressing the variation of the antenna gain with respect to the frequency (frequency flatness).

A wide-band antenna according to the present invention is a wide-band antenna including radiation devices and an electric supply line, the radiation devices constituted by a first radiation device and a second radiation device, and the electric supply line being constituted by a coaxial cable, wherein the first radiation device and the second radiation devices are conductor members which are placed opposite to each other across an electric supply point for supplying electricity to the radiation devices and are shaped to be line-symmetrical with respect to a straight line passing through the electric supply line, the first radiation device is connected to an inner core of the electric supply line, the second radiation device is connected to an outer conductor of the electric supply line, and a conductor member constituted by two electrode portions is connected to the second radiation device, the two electrode portions being placed such that their longitudinal axis is parallel to the electric supply line and being line-symmetrical with respect to the straight line passing through the electric supply line.

With the structure, when a signal electric current is supplied through the electric supply line to the radiation devices, the radiation devices generate signal radio waves. Further, at this time, the electrode portions provided therein suppresses the leak electric current flowing through the electric supply line. Namely, the electrode portions are placed such that their longitudinal axis is parallel to the electric supply line, which causes the electromagnetic field induced by the leak electric current flowing through the electric supply line to be cancelled by the electromagnetic field generated from the electric current flowing through the electrode portions, thus canceling the leak electric current flowing through the electric supply line. This can suppress the adverse influence of the leak electric current on the frequency flatness.

Further, in the wide-band antenna, preferably, the following equation is satisfied, wherein a diameter of the outer conductor of the electric supply line is a, a distance between outer edges of the two electrode portions is b, a longitudinal length of the electrode portions is c, and the wavelength corresponding to a lower limit frequency within a usage frequency band is λ₀.

5≦b/a≦13

c/λ₀≦0.25

−36.4×c/λ₀+13≦b/a

With the structure, the leak-current canceling effect can sufficiently function within the entire usage frequency band.

Further, in the wide-band antenna, the radiation devices can be formed from conductive patterns forming the first radiation device and the second radiation device which are formed on at least one of surfaces of a dielectric substrate.

With the structure, the radiation devices are placed on the surface of the dielectric member, which can offer the advantage of reduction of the size of the electrodes due to a wavelength-shortening effect of the dielectric member. Further, a mechanical strength can be provided to the radiation devices.

Further, the wide-band antenna can include plural radiation devices, wherein the radiation devices can be placed such that the electric supply points of these radiation devices are coincident with one another and the straight lines of these radiation devices are overlapped with one another.

With the aforementioned structure, it is possible to cause the electromagnetic field induced by the leak electric current flowing through the electric supply line to be cancelled by the electromagnetic field generated from the electric current flowing through the electrode portions, thus canceling the leak electric current flowing through the electric supply line. This can suppress the adverse influence of the leak electric current on the frequency flatness.

Further, in the wide-band antenna, preferably, the following equation is satisfied, wherein the diameter of the outer conductor of the electric supply line is a, the distance between the outer edges of the two electrode portions is b, the longitudinal length of the electrode portions is c, and the wavelength corresponding to a lower limit frequency within a usage frequency band is λ₀.

6≦b/a≦16

−50×c/λ₀+16≦b/a≦−125×c/λ₀+33.5

With the structure, the leak-current canceling effect can sufficiently function within the entire usage frequency band.

Further, in the wide-band antenna, the radiation devices can be covered with a dielectric case.

With the structure, the radiation devices are covered with the dielectric case, which can offer the advantage of reduction of the size of the electrodes due to the wavelength-shortening effect of the dielectric case.

Further, in the wide-band antenna, preferably, the following equation is satisfied, wherein the diameter of the outer conductor of the electric supply line is a, the distance between the outer edges of the two electrode portions is b, the longitudinal length of the electrode portions is c, and the wavelength corresponding to a lower limit frequency within a usage frequency band is λ₀.

6≦b/a≦11.5

c/λ₀≦0.25

−36.4×c/λ₀+11.5≦b/a

With the structure, the leak-current canceling effect can sufficiently function within the entire usage frequency band.

Further, in the wide-band antenna, preferably, the following equation is satisfied, wherein the diameter of the outer conductor of the electric supply line is a, the distance between the outer edges of the two electrode portions is b, the longitudinal length of the electrode portions is c, and the wavelength corresponding to a lower limit frequency within a usage frequency band is λ₀.

b/a≦12

−33.3*c/λ₀+12≦b/a≦−100×c/λ₀+24

With the structure, the leak-current canceling effect can sufficiently function within the entire usage frequency band.

Further, in the wide-band antenna, preferably, the following equation is satisfied, wherein the diameter of the outer conductor of the electric supply line is a, the distance between the outer edges of the two electrode portions is b, and a horizontal width of the electrode portions is w.

0.17≦2w/(b−a)≦0.95

With the structure, the leak-current canceling effect can sufficiently function within the entire usage frequency band.

Further, another wide-band antenna according to the present invention is a wide-band antenna including radiation devices and an electric supply line, the radiation devices constituted by a first radiation device and a second radiation device, and the electric supply line being constituted by a coaxial cable, wherein the first radiation device is a conductor member with a conical shape connected to an inner core of the electric supply line, the second radiation device is a conductor member being connected to an outer conductor of the electric supply line and including a radiation portion with a conical shape and a tubular-shaped conductor mounted to a bottom surface of the radiation portion such that the tubular-shaped conductor extends downwardly, and the first radiation device and the second radiation device are placed such that the apexes of their conical shapes are opposed to each other, and the tubular-shaped conductor is placed such that a center axis of the tubular-shaped conductor is parallel to the electric supply line.

With the structure, it is possible to cause the electromagnetic field induced by the leak electric current flowing through the electric supply line to be cancelled by the electromagnetic field generated from the electric current flowing through the electrode portions, thus canceling the leak electric current flowing through the electric supply line. This can suppress the adverse influence of the leak electric current on the frequency flatness.

Further, in the wide-band antenna, preferably, the following equation is satisfied, wherein the diameter of the outer conductor of the electric supply line is a, the distance between the outer edges of the two electrode portions is b, an axial length of the tubular-shaped conductor is c, and the wavelength corresponding to a lower limit frequency within a usage frequency band is λ₀.

6≦b/a≦9

c/λ₀≦0.25

−30×c/λ₀+9≦b/a

With the structure, the leak-current canceling effect can sufficiently function within the entire usage frequency band.

Further, in the wide-band antenna, preferably, the following equation is satisfied, wherein the diameter of the outer conductor of the electric supply line is a, an outer diameter of the tubular-shaped conductor is b, and a radial thickness of the tubular-shaped conductor is w.

0.17≦2w/(b−a)≦0.95

With the structure, the leak-current canceling effect can sufficiently function within the entire usage frequency band.

A wide-band antenna according to the present invention is a wide-band antenna including radiation devices and an electric supply line, the radiation devices being constituted by a first radiation device and a second radiation device, and the electric supply line being constituted by a coaxial cable, wherein the first radiation device and the second radiation devices are conductor members which are placed opposite to each other across an electric supply point for supplying electricity to the radiation devices and are shaped to be line-symmetrical with respect to a straight line passing through the electric supply line, the first radiation device is connected to an inner core of the electric supply line, the second radiation device is connected to an outer conductor of the electric supply line, and a conductor member constituted by two electrode portions is connected to the second radiation device, the two electrode portions being placed such that their longitudinal axis is parallel to the electric supply line and being line-symmetrical with respect to the straight line passing through the electric supply line.

Accordingly, the electromagnetic field induced by the leak electric current flowing through the electric supply line is cancelled by the electromagnetic field generated from the electric current flowing through the electrode portions, thereby causing the leak electric current flowing through the electric supply line to be cancelled. This can offer the advantage of suppressing the adverse influence of the leak electric current on the frequency flatness.

### BRIEF DESCRIPTION OF THE DRAWINGS

FIG. 1 shows a plan view illustrating the schematic structure of a wide-band antenna according to a first embodiment, illustrating an embodiment of the present invention;

FIG. 2 shows a view illustrating the connection between a first radiation member and a second radiation member and an electric supply line in the wide-band antenna;

FIG. 3 shows a graph illustrating the condition for realizing frequency flatness in the wide-band antenna shown in FIG. 1;

FIG. 4 shows a plan view illustrating a modified example of the wide-band antenna according to the first embodiment;

FIG. 5 shows a perspective view illustrating the schematic structure of a wide-band antenna according to a second embodiment;

FIG. 6 shows a graph illustrating the condition for realizing frequency flatness in the wide-band antenna shown in FIG. 5;

FIG. 7 shows a perspective view illustrating the schematic structure of a wide-band antenna according to a third embodiment;

FIG. 8 shows a graph illustrating the condition for realizing frequency flatness in the wide-band antenna shown in FIG. 7;

FIG. 9 shows a plan view illustrating a modified example of the wide-band antenna according to the third embodiment;

FIG. 10 shows a graph illustrating the condition for realizing frequency flatness in the wide-band antenna shown in FIG. 9;

FIG. 11 shows a perspective view illustrating the schematic structure of a wide-band antenna according to a fourth embodiment;

FIG. 12 shows a graph illustrating the condition for realizing frequency flatness in the wide-band antenna shown in FIG. 11;

FIG. 13 shows a graph illustrating the change of the leak electric current flowing to the electric supply line due to the reduction of the size of an antenna;

FIG. 14 shows a graph illustrating measurement data about the radiation gain with respect to the frequency, resulted from measurement using the wide-band antenna shown in FIG. 9;

FIG. 15 shows a view illustrating the measurement environment for obtaining the measurement data of FIG. 14;

FIG. 16 shows a view illustrating the dimensional relationship of a wide-band antenna;

FIG. 17 shows a graph illustrating the relationship between a horizontal width of the electrode portions and the frequency flatness;

FIG. 18 shows a view illustrating exemplary placement of communication apparatuses including wide-band antennas according to the present invention;

FIG. 19 shows a graph illustrating the relationships between the frequency and the antenna gain of an antenna with frequency flatness and an antenna having no frequency flatness; and

FIG. 20 shows a view illustrating omni-directionality of an antenna.

### DETAILED DESCRIPTION OF THE PREFERRED EMBODIMENTS

### First Embodiment

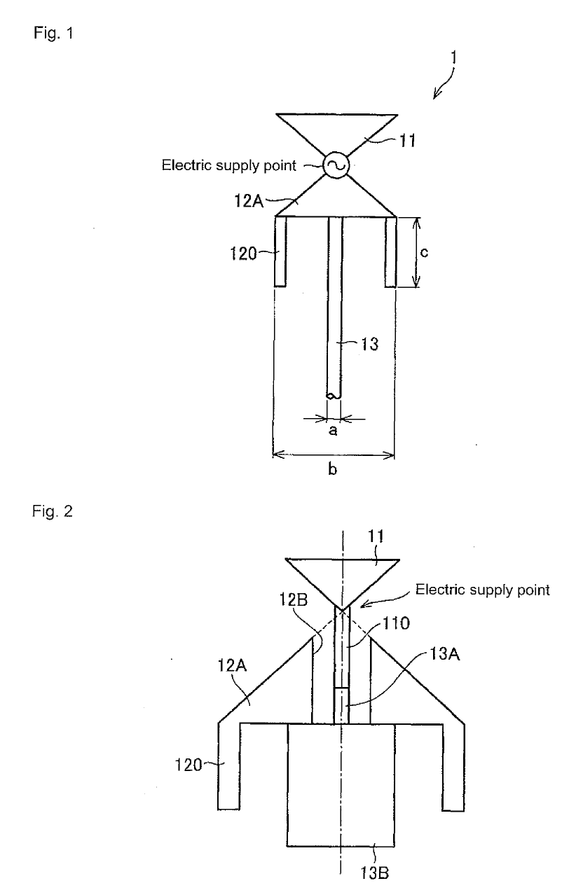

Hereinafter, an embodiment of the present invention will be described, with reference to FIGS. 1 to 4. At first, FIGS. 1 and 2 illustrate a schematic shape of a wide-band antenna according to the present first embodiment.

The wide-band antenna 1 includes a first radiation device 11, a second radiation device 12, and an electric supply line 13, as illustrated in FIG. 1 and FIG. 2. The first radiation device 11 is a conductor member having an isosceles-triangle shape. Further, although not illustrated in FIG. 1, the second radiation device 12 is constituted by a slit 12B formed by removing a conductor portion near the apex of its isosceles-triangle shape, and a radiation portion 12A, wherein two electrode portions 120 are mounted and coupled to the second radiation device 12 such that the electrode portions 120 extend downwardly from the opposite ends of the bottom side of the radiation portion 12A. Further, the electric supply line 13 is a coaxial cable. The electrode portions 120 are placed such that their longitudinal axis is parallel to the electric supply line 13.

The first radiation device 11 and the second radiation device 12 are placed such that the apexes of their isosceles-triangle shapes are opposed to each other, and the position at which the apexes of their isosceles-triangle shapes are contacted with each other forms an electric supply point. As illustrated in FIG. 2, the first radiation device 11 is connected at its apex portion to an inner core 13A of the electric supply line 13, while the second radiation device 12 is connected at its bottom side portion to an outer conductor 13B in the electric supply line 13. Further, inside the slit 12B provided in the second radiation device 12, there is placed a connection conductor 110 extended from the first radiation device, in order to enable connection of the first radiation device 11 to the inner core 13A in the electric supply line 13.

In this case, the radiation portion 12A of the second radiation device 12 and the outer conductor 13B of the electric supply line 13 are electrically connected to each other, which maintains the slit 12B and the outer conductor 13B at the same potential. With this structure, the connection conductor 110 is subjected to a shielding effect which is equivalent to the shielding effect offered to the electric supply line 13 constituted by a coaxial cable, in the area surrounded by the slit 12B and the radiation portion 12A.

When a signal electric current is supplied through the electric supply line 13 to the radiation devices (the terms “radiation devices” will refer to the first radiation device 11 and the second radiation device 12, hereinafter) in the wide-band antenna 1, the radiation devices generate signal radio waves. Further, at this time, the electrode portions 120 provided thereto suppress the leak electric current flowing through the electric supply line 13. Namely, the electrode portions 120 are placed such that their longitudinal axis is parallel to the electric supply line 13 in the structure of FIG. 1, which causes the electromagnetic field induced by the leak electric current flowing through the electric supply line 13 to be cancelled by the electromagnetic field generated from the electric current flowing through the electrode portions 120, thus canceling the leak electric current flowing through the electric supply line 13.

Further, it is necessary that the leak-current canceling effect sufficiently functions over the entire usage frequency band used by the wide-band antenna 1. Otherwise, a width between the maximum and minimum antenna gain values within the usage frequency band will be increased, thereby degrading the frequency flatness (the uniformity of the antenna gain within the usage frequency band). Further, in the present embodiment, a state where frequency flatness is realized refers to a state where the width between the maximum and minimum antenna gain values within the usage frequency band is equal to or less than 6 dB. Generally, it has been theoretically revealed that there is a correlation between the communication distance and the transmission electric power, and the reduction of the transmission electric power by 6 dB induces reduction of the communication distance by half. Accordingly, assuming that a communication apparatus generates constant transmission electric power for every frequency, it is desirable that the difference between the maximum and minimum antenna gain values within the usage frequency band is made equal to or less than 6 dB. Further, in the present embodiment, if the difference between the maximum and minimum antenna gain values is equal to or less than 6 dB within the range of −30 degree to +30 degree with respect to a direction orthogonal to the antenna, frequency flatness is deemed to be realized.

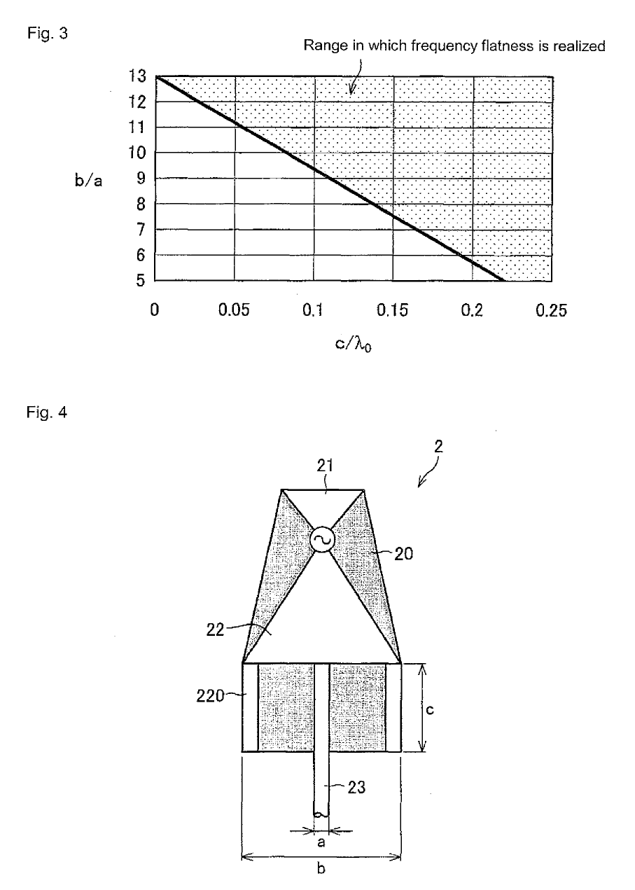

In this case, conditions required for realizing frequency flatness in the wide-band antenna 1 were determined from analyses, assuming that a diameter of the electric supply line 13 is a, a horizontal distance between the two electrode portions 120 (a distance between their outer edges) is b, and a vertical length of the electrode portions 120 is c. FIG. 3 illustrates the results of the analyses. In FIG. 3, the vertical axis represents b/a, while the horizontal axis represents c/λ₀, wherein λ₀ designates the wavelength corresponding to the lower limit frequency within the usage frequency band of the wide-band antenna 1.

Referring to FIG. 3, under a condition where the following equations (1) to (3) hold, frequency flatness is realized in the wide-band antenna 1 having the structure illustrated in FIG. 1.

5≦b/a≦13 (1)

c/λ₀≦0.25 (2)

−36.4×c/λ₀+13≦b/a (3)

Further, while the first radiation device 11 and the second radiation device 12 have been described as having isosceles-triangle shapes with reference to FIG. 1 and FIG. 2, their shapes can be replaced with arc shapes or semicircular shapes. Furthermore, the first radiation device 11 and the second radiation device 12 can have isosceles-triangle shapes having curves at their respective sides, provided that their shapes are placed opposite to the electric supply point and are line-symmetrical with respect to a straight line passing through the electric supply point.

Further, the two electrode portions 120 can be placed at any positions on the button side of the radiation portion 12A of the second radiation device 12, but, when they are placed at the opposite ends of the bottom side, the effect of the present invention emerges most prominently. When the two electrode portions 120 are placed at the opposite ends thereof, an electric current smoothly flows through the two electrode portions 120, thereby offering a sufficient leak-current canceling effect.

FIG. 4 is a modified example of the wide-band antenna 1 illustrated in FIG. 1. The wide-band antenna 2 illustrated in FIG. 4 is structured to have conductive patterns forming a first radiation device 21 and a second radiation device 22 which are formed on at least one of surfaces of a dielectric substrate 20, wherein the radiation devices are connected to an electric supply line 23 formed from a coaxial cable.

The first radiation device 21 is a conductor pattern having an isosceles-triangle shape. Further, the second radiation device 22 is a conductor pattern constituted by a slit formed by removing a conductor portion near the apex of its isosceles-triangle shape (not illustrated), and a radiation portion. Two electrode portions 220 are mounted and connected to the second radiation portion 22, such that they extend downwardly from the opposite ends of the bottom side of the radiation portion. The first radiation device 21 and the second radiation device 22 are placed such that the apexes of their isosceles-triangle shapes are faced to each other, and the electrode portions 220 are placed such that their longitudinal axis is parallel to the electric supply line 23. In the wide-band antenna 2, similarly, the first radiation device 21 is connected at its apex portion to an inner core of the electricity supply line 23, while the second radiation device 22 is connected at its bottom side portion to an outer conductor in the electric supply line 23.

With the wide-band antenna 2 structured to have conductive patterns forming radiation devices which are formed on the surface of the dielectric substrate 20 as a dielectric member, it is possible to offer the advantage of reducing the size of the electrodes due to the wavelength-shortening effect of the dielectric member. Further, it is also possible to provide a mechanical strength to the radiation devices.

Similarly, frequency flatness is realized in the wide-band antenna 2, under a condition where the equations (1) to (3) are satisfied, assuming that a diameter of the electric supply line 23 is a, a horizontal distance between the two electrode portions 220 (a distance between their outer edges) is b, and the vertical length of the electrode portions 220 is c.

### Second Embodiment

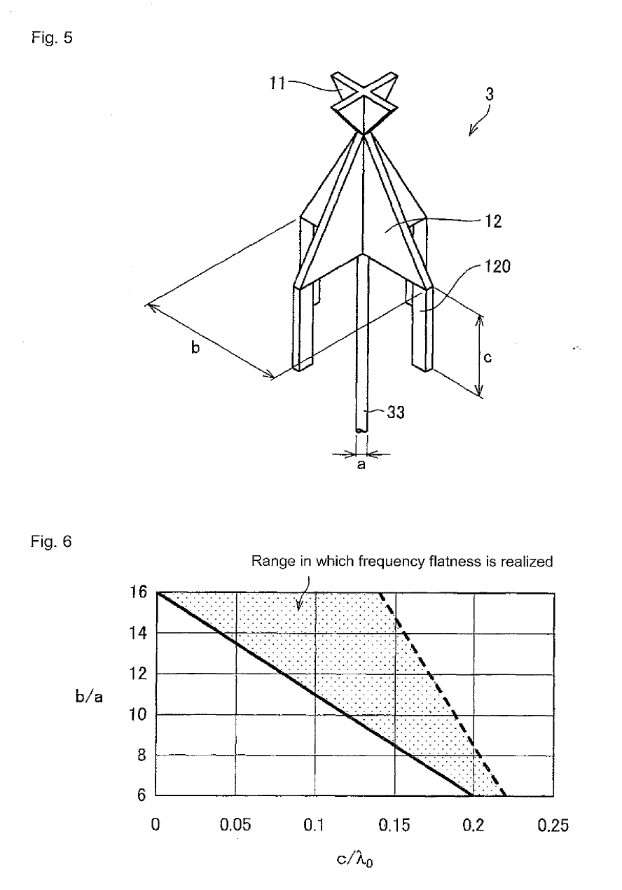

Hereinafter, another embodiment of the present invention will be described, with reference to FIGS. 5 and 6. At first, FIG. 5 illustrates a schematic shape of a wide-band antenna according to the present second embodiment.

The wide-band antenna 3 illustrated in FIG. 5 is structured to include radiation devices constituted by two antenna patterns similar to that of the wide-band antenna 1 illustrated in FIG. 1 which are combined with each other such that they intersect along a vertical line-symmetrical axis, and to include an electric supply line 33 connected to the radiation devices. In FIG. 5, the respective antenna patterns combined with each other are designated by the same reference numbers as those for the wide-band antenna 1 of FIG. 1.

Further, while the wide-band antenna 3 of FIG. 5 is illustrated as being structured to include two antenna patterns combined with each other, it can be structured to include three antenna patterns combined with one another. Also, the respective antenna patterns to be combined with one another can be structured by forming conductor patterns forming a second radiation device 21 and a second radiation device 22 on at least one of the surfaces of a dielectric substrate, as illustrated in FIG. 4.

In this case, conditions required for realizing frequency flatness in the wide-band antenna 3 are determined from analyses, assuming that a diameter of the electric supply line 33 is a, the horizontal distance between the two electrode portions 120 (the distance between their outer edges) is b, and the vertical length of the electrode portions 120 is c. FIG. 6 illustrates the results of the analyses. In FIG. 6, the vertical axis represents b/a, while the horizontal axis represents c/λ₀, wherein λ₀ designates the wavelength corresponding to the lower limit frequency within the usage frequency band of the wide-band antenna 3.

Referring to FIG. 6, under a condition where the following equations (4) and (5) are satisfied, frequency flatness is realized in the wide-band antenna 3 having the structure illustrated in FIG. 5.

6≦b/a≦16 (4)

−50×c/λ₀+16≦b/a≦−125×c/λ₀+33.5 (5)

Further, with the wide-band antenna 3 illustrated in FIG. 6, it is possible to enhance the omni-directionality in a horizontal in-plane direction, in comparison with the wide-band antenna 1 illustrated in FIG. 1. Namely, in the case of structures having a combination of plural antenna patterns as the wide-band antenna 3, their omni-directionality tends to increase with increasing number of antenna patterns.

### Third Embodiment

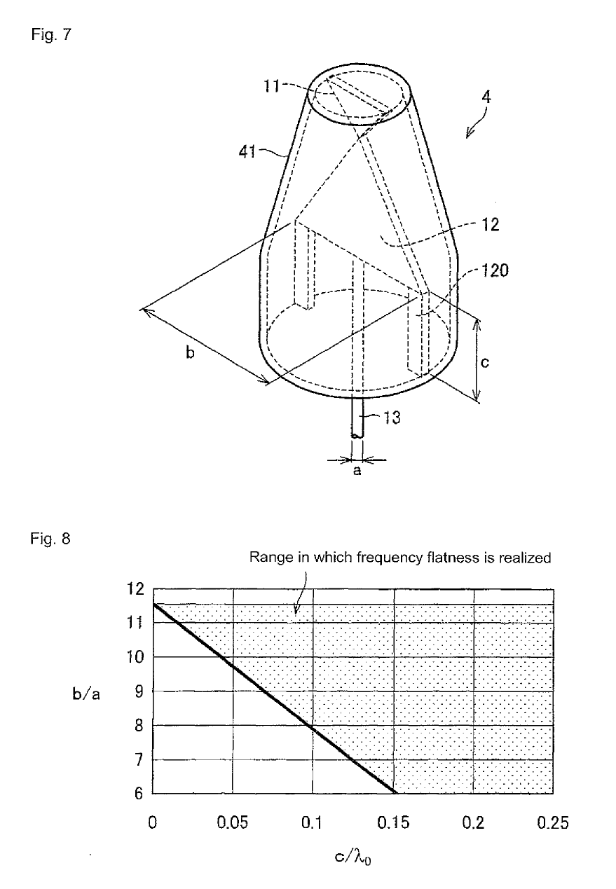

Hereinafter, another embodiment of the present invention will be described, with reference to FIGS. 7 to 10. At first, FIG. 7 illustrates a schematic shape of a wide-band antenna according to the present third embodiment.

The wide-band antenna 4 illustrated in FIG. 7 is structured to include the same radiation devices as those of the wide-band antenna 1 illustrated in FIG. 1 and a dielectric case 41 covering the radiation devices. In FIG. 7, the radiation devices and an electric supply line are designated by the same reference numbers as those for the wide-band antenna 1 of FIG. 1. Further, the radiation devices within the dielectric case 41 can be constituted by plural radiation devices combined with one another such that they intersect along a vertical line-symmetrical axis, as in the wide-band antenna 4 illustrated in FIG. 5.

In this case, conditions required for realizing frequency flatness in the wide-band antenna 4 are determined from analyses, assuming that the diameter of the electric supply line 13 is a, the horizontal distance between the two electrode portions 120 (the distance between their outer edges) is b, and the vertical length of the electrode portions 120 is c. FIG. 8 illustrates the results of the analyses. In FIG. 8, the vertical axis represents b/a, while the horizontal axis represents c/λ₀, wherein λ₀ designates the wavelength corresponding to the lower limit frequency within the usage frequency band of the wide-band antenna 4.

Referring to FIG. 8, under a condition where the following equations (6) and (8) hold, frequency flatness is realized in the wide-band antenna 4 having the structure illustrated in FIG. 7.

6≦b/a≦11.5 (6)

c/λ₀≦0.25 (7)

−36.4×c/λ₀+11.5≦b/a (8)

As described above, the wide-band antenna 4 is structured to include the dielectric case 41 covering the radiation devices, which offers the advantage of reducing the size of the electrodes due to the wavelength-shortening effect of the dielectric case.

Further, in the present invention, the wide-band antenna 2 illustrated in FIG. 4 can be covered with a dielectric case similar to the dielectric case. In the wide-band antenna with such a structure, similarly, frequency flatness is realized under a condition where the equations (6) to (8) hold.

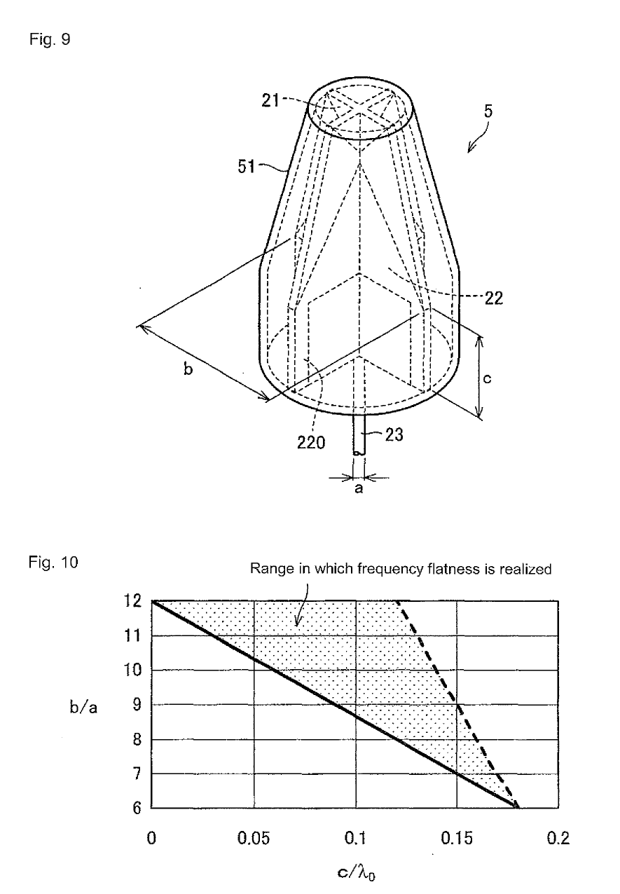

FIG. 9 illustrates a modified example of the wide-band antenna 4 illustrated in FIG. 7. The wide-band antenna 5 illustrated in FIG. 9 is structured to include radiation devices and a dielectric case 51 covering the radiation devices, wherein the radiation devices are constituted by two conductive patterns forming a first radiation device 1 and a second radiation device 22 which are formed on at least one of the surfaces of dielectric substrates 20, these two conducive patterns being combined with each other such that they intersect along a vertical line-symmetrical axis. In FIG. 9, the radiation devices and an electric supply line are designated by the same reference numbers as those in FIG. 4. Further, while the wide-band antenna 3 of FIG. 9 is illustrated as being structured to have the two antenna patterns combined with each other, it can be structured to have combined three antenna patterns.

In this case, conditions required for realizing frequency flatness in the wide-band antenna 5 are determined from analyses, assuming that the diameter of the electric supply line 23 is a, a horizontal distance between the two electrode portions 220 (a distance between their outer edges) is b, and a vertical length of the electrode portions 220 is c. FIG. 10 illustrates the results of the analyses. In FIG. 10, the vertical axis represents b/a, while the horizontal axis represents c/λ₀, wherein λ₀ designates the wavelength corresponding to the lower limit frequency within the usage frequency band of the wide-band antenna 5.

Referring to FIG. 10, under a condition where the following equations (9) and (10) are satisfied, frequency flatness is realized in the wide-band antenna 5 having the structure illustrated in FIG. 9.

b/a≦12 (9)

−33.3×c/λ₀+12≦b/a≦−100×c/λ₀+24 (10)

### Fourth Embodiment

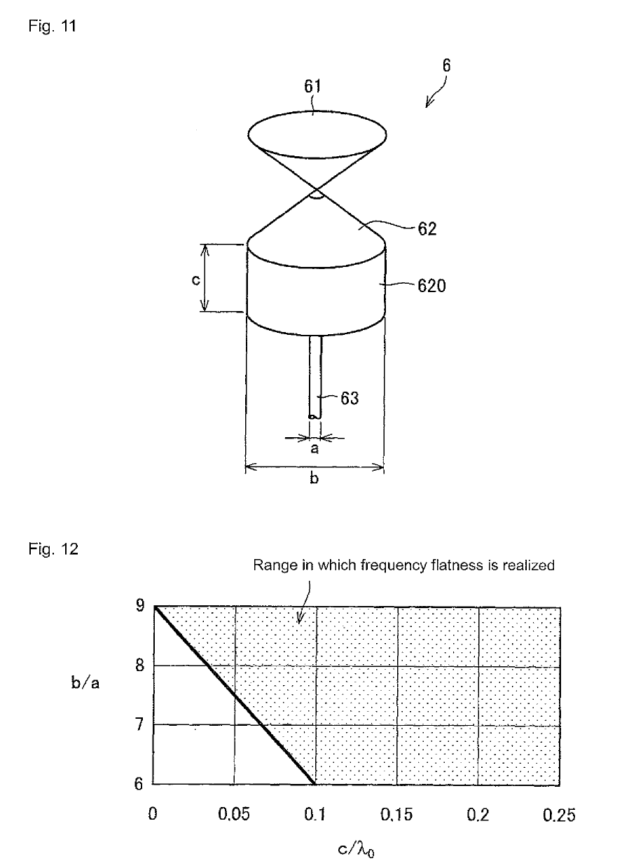

Hereinafter, another embodiment of the present invention will be described, with reference to FIGS. 11 to 18. At first, FIG. 11 illustrates a schematic shape of a wide-band antenna according to the present fourth embodiment.

The wide-band antenna 6 illustrated in FIG. 11 is structured to include a first radiation device 61, a second radiation device 62, and an electric supply line 63. The first radiation device 61 and the second radiation device 62 are conductor members with conical shapes. Further, a tubular-shaped conductor 620 is mounted to the second radiation device 62 such that the tubular-shaped conductor 620 extends downwardly from an outer edge of a bottom surface of the second radiation device 62. Further, the electric supply line 63 is constituted by a coaxial cable. The tubular-shaped conductor 620 is placed such that a center axis of the tubular-shaped conductor 620 is parallel to the electric supply line 63.

The first radiation device 61 and the second radiation device 62 are placed such that the apexes of their conical shapes are opposed to each other, and the position at which the apexes of their conical shapes are contacted with each other forms an electric supply point. The first radiation device 61 is connected at its apex portion to an inner core of the electric supply line 63, while the second radiation device 62 is connected at its bottom surface portion to an outer conductor in the electric supply line 63.

Namely, the wide-band antenna 6 is structured by connecting the tubular-shaped conductor 620 to a bi-conical antenna having an unbalanced electric supply line, at a bottom surface of the bi-conical antenna, in a direction of the placement of the electric supply line 63.

In the wide-band antenna 6, the tubular-shaped conductor 620 is placed such that the center axis of the tubular-shaped conductor 620 is parallel to the electric supply line 63, which causes the electromagnetic field induced by the leak electric current flowing through the electric supply line 63 to be cancelled by the electromagnetic field generated from the electric current flowing through the tubular-shaped conductor 620, thus canceling the leak electric current flowing through the electric supply line 63.

In this case, conditions required for realizing frequency flatness in the wide-band antenna 6 were determined from analyses, assuming that a diameter of the electric supply line 63 is a, an outer diameter of the tubular-shaped conductor 620 is b, and an axial length of the tubular-shaped conductor 620 is c. FIG. 12 illustrates the results of the analyses. In FIG. 12, the vertical axis represents b/a, while the horizontal axis represents c/λ₀, wherein λ₀ designates the wavelength corresponding to the lower limit frequency within the usage frequency band of the wide-band antenna 6.

Referring to FIG. 12, under a condition where the following equations (11) to (13) hold, frequency flatness is realized in the wide-band antenna 6 having the structure illustrated in FIG. 11.

6≦b/a≦9 (11)

c/λ₀≦0.25 (12)

−30×c/λ₀+9≦b/a (13)

As antennas having wide-band characteristics, bi-conical antennas have been well known. In cases of supplying electricity to such bi-conical structures in an unbalanced manner, when the radiation devices are sufficiently greater than the electric supply line, the influence of the electric supply line is negligible. However, when the radiation devices have reduced sizes, the electric supply line becomes a part of the radiation devices, which causes the difference between the maximum and minimum antenna gain values in a horizontal in-plane direction within the usage frequency band to be equal to or more than 6 dB due to the influence of the electric supply line, thereby degrading the frequency flatness.

In order to address this, a tubular-shaped device can be mounted to the bi-conical antenna such that the tubular-shaped device surrounds the electric supply line, which can reduce the leak electric current flowing to the electric supply line, thereby causing the difference between the maximum and minimum antenna gain values in a horizontal in-plain direction within the usage frequency band to be equal to or less than 6 dB. The wide-band antenna structured by mounting the tubular-shaped device to the bi-conical antenna corresponds to the wide-band antenna 6 which has been described in the fourth embodiment.

However, such a wide-band antenna having a tubular-shaped device mounted therein has the problem of complicacy of the fabrication processes thereof, while having higher performance. In order to address this, plural flat-plain antenna patterns can be combined with one another, which enables easily fabricating a wide-band antenna having wide-band characteristics and also being capable of realizing frequency flatness. The wide-band antenna structured to include a combination of plural flat-plane antenna patterns corresponds to the wide-band antenna 3 described in the second embodiment.

Further, even with a structure using only a single flat-plane antenna, it is possible to realize a wide-band antenna having wide-band characteristics and also being capable of realizing frequency flatness. The wide-band antenna structured to include only a single flat-plane antenna pattern corresponds to the wide-band antenna 1 described in the first embodiment.

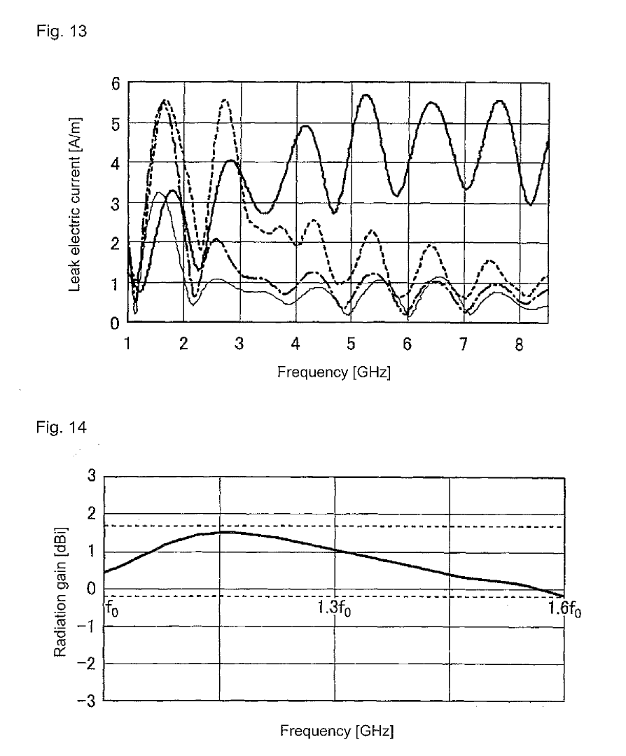

FIG. 13 and Table. 1 illustrate the results of analyses of the influence of the reduction of the size of an antenna on the frequency flatness. The results of analyses show the leak electric current flowing to the electric supply line with respect to the change of the ratio of b to a (FIG. 13), and the maximum-to-minimum antenna gain width within the usage frequency band (in the range of 3 to 5 GHz, in this case) (Table 1), assuming that a diameter of the electric supply line is a, and a diameter of a bottom surface of the conical shape is b.

TABLE 1

a:b

| | 1:2 | 1:6 | 1:10 | 1:14 |
|---|---|---|---|---|
| max-min@3-5 GHz | 14.5 | 17.1 | 7 | 3.3 |

The results of analyses illustrated in FIG. 13 and Table. 1 reveal that, as the ratio of b to a is decreased, the leak electric current increases, thereby making it impossible to ensure frequency flatness.

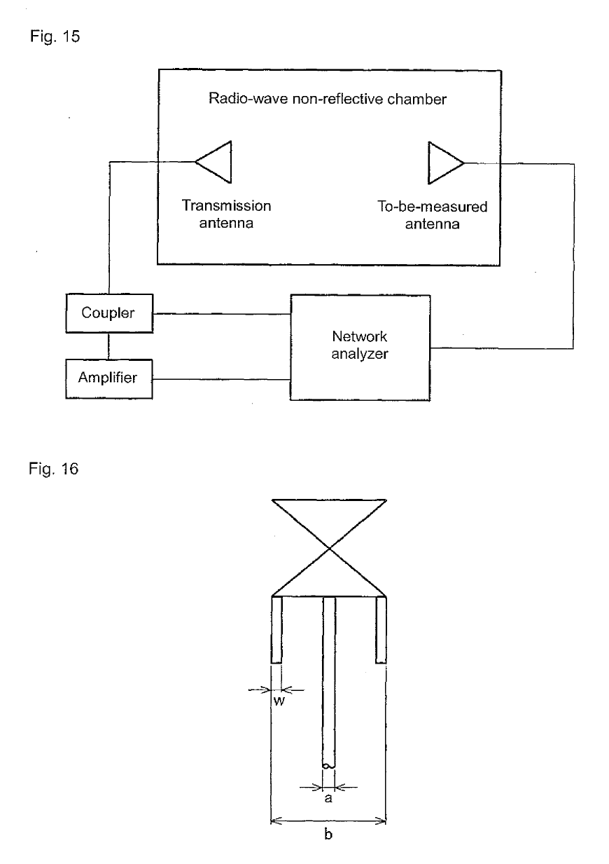

FIG. 14 illustrates measurement data about the radiation gain (antenna gain) with respect to the frequency, which was resulted from measurement using the wide-band antenna 5 illustrated in FIG. 9. This measurement was conducted using a measurement method described in “Three-Antenna Method” (“Antenna Engineering Handbook”, edited by Institute of Electronics, Information and Communication Engineers, published by Ohm Corporation, pages. 431 to 435). The three-antenna method is a method which performs measurements on a standard antenna having known calibration values and then performs measurements on a to-be-measured antenna, which enables determination of actual measurement values about the antenna which are corrected in the measurement-system errors. Further, FIG. 15 illustrates the measurement environment used herein.

In the measurements, the wide-band antenna 5 as the to-be-measured antenna had a value of b/a of 10 and a value of c/λ₀ of 0.12. Further, the usage frequency band was assumed to be the range from f₀ to 1.6 f₀. The result illustrated in FIG. 14 reveals that, within the frequency range of from the usage lower limit frequency f₀ to the upper limit frequency 1.6 f₀, the maximum-to-minimum radiation gain width is about 2 dB, which is significantly smaller than 6 dB, thereby realizing preferable frequency flatness.

While, in the wide-band antennas 1 to 6 described in the first to fourth embodiments, the shape of the electrode portions of the second radiation device (or the radial cross-sectional shape of the tubular-shaped conductor) is a rectangular shape, the present invention is not limited thereto, and their shape can be, for example, an elliptical shape, provided that it has a longitudinal axis parallel to the electric supply line.

Further, the present applicants have found that, when the electrode portions (or the tubular-shaped conductor) of the second radiation device have an excessively small width in the horizontal direction, it is impossible to produce a sufficient effect of canceling the lead electric current flowing to the electric supply line within the entire usage frequency band, thereby degrading the frequency flatness in the wide-band antenna.

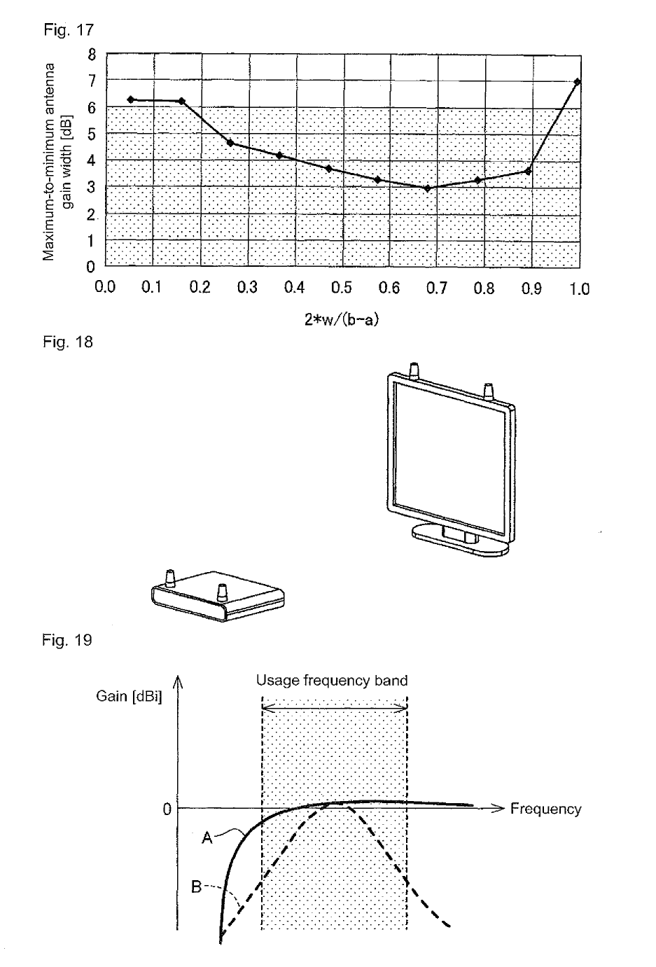

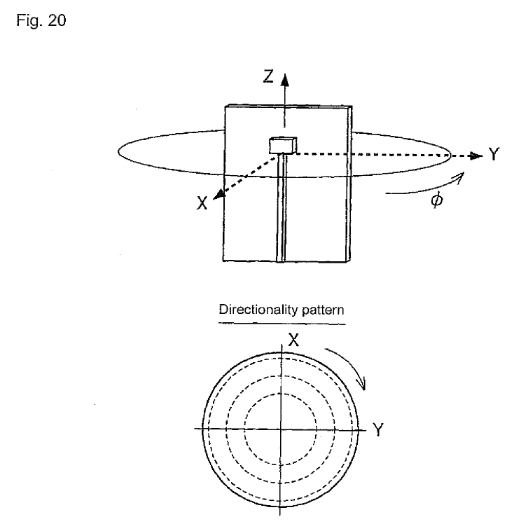

FIG. 17 illustrates the relationship between the value of 2w/(b−a) and the frequency flatness, assuming that the diameter of the electric supply line is a, the horizontal distance between the two electrode portions (the distance between their outer edges) is b, and a horizontal width of the electrode portions of the second radiation device is w (see FIG. 16). In FIG. 17, the horizontal axis represents the value of 2w/(b−a), while the vertical axis represents the difference between the maximum and minimum antenna gain values (the maximum-to-minimum antenna gain width) within the usage frequency band. Further, in the case of the wide-band antenna 6 illustrated in FIG. 11, the outer diameter of the tubular-shaped conductor 620 corresponds to the b, and a radial thickness of the tubular-shaped member 620 corresponds to the w.

As can be seen from FIG. 17, in cases where the value of 2W/(b−a) is smaller, the maximum-to-minimum antenna gain width exceeds 6 dB and, thus, frequency flatness can not be realized, but in cases where the value of 2W/(b−a) is larger, the maximum-to-minimum antenna gain width is below 6 dB and, thus, frequency flatness can be realized. Further, in FIG. 17, when the value of 2W/(b-a) substantially reaches 1, the value of the maximum-to-minimum antenna gain width is about 7 dB. It is considered that this phenomenon was because inner edges of the electrode portions were significantly close to an outer edge of the electric supply line, which eliminated the space for generating an electromagnetic field for canceling the leak electric current flowing to the electric supply line.

Referring to FIG. 17, under a condition where the following equation (14) holds, preferable frequency flatness is realized in the wide-band antenna according to the present invention.

0.17≦2w/(b−a)≦0.95 (14)

The wide-band antenna 1 or 6 described in the first or fourth embodiment can be applied to an electronic apparatus which includes an antenna device having the wide-band antenna and transmits information using the antenna device.

Such an electronic apparatus can be preferably applied to communication methods for transmitting information among plural communication apparatuses each including an antenna device, as illustrated in FIG. 18, for example. Further, in the present embodiments, if the difference between the maximum and minimum antenna gain values is equal to or less than 6 dB within the range of −30 degree to +30 degree with respect to a direction orthogonal to the antenna, frequency flatness is deemed to be realized. Accordingly, it is preferable that the antenna devices included in these communication apparatuses are provided within the range of −30 degree to +30 degree with respect to the directions orthogonal to the respective communication apparatuses.

1. A wide-band antenna comprising:
radiation devices including a first radiation device and a second radiation device; and
an electric supply line including a coaxial cable,
wherein the first radiation device and the second radiation devices are conductor members which are placed opposite to each other across an electric supply point for supplying electricity to the radiation devices and are shaped to be line-symmetrical with respect to a straight line passing through the electric supply line,
the first radiation device is connected to an inner core of the electric supply line,
the second radiation device is connected to an outer conductor of the electric supply line, and
a conductor member including two electrode portions is connected to the second radiation device, the two electrode portions being placed such that their longitudinal axis is parallel to the electric supply line and being line-symmetrical with respect to the straight line passing through the electric supply line.

2. The wide-band antenna according to claim 1, wherein the following equation is satisfied, wherein a diameter of the outer conductor of the electric supply line is a, a distance between outer edges of the two electrode portions is b, a longitudinal length of the electrode portions is c, and a wavelength corresponding to a lower limit frequency within a usage frequency band is λ₀.
5≦b/a≦13
c/λ₀≦0.25
−36.4×c/λ₀+13≦b/a

3. The wide-band antenna according to claim 1, wherein
the radiation devices are formed from conductive patterns forming the first radiation device and the second radiation device which are formed on at least one of surfaces of a dielectric substrate.

4. The wide-band antenna according to claim 1, comprising plural radiation devices,
wherein the radiation devices are placed such that the electric supply points of these radiation devices are coincident with one another and the straight lines of these radiation devices are coincident with one another.

5. The wide-band antenna according to claim 4, wherein the following equation is satisfied, wherein the diameter of the outer conductor of the electric supply line is a, the distance between the outer edges of the two electrode portions is b, the longitudinal length of the electrode portions is c, and the wavelength corresponding to a lower limit frequency within a usage frequency band is λ₀.
6≦b/a≦16
−50×c/λ₀+16≦b/a≦−125×c/λ₀+33.5

6. The wide-band antenna according to claim 1, wherein
the radiation devices are covered with a dielectric case.

7. The wide-band antenna according to claim 1, wherein the following equation is satisfied, wherein the diameter of the outer conductor of the electric supply line is a, the distance between the outer edges of the two electrode portions is b, the longitudinal length of the electrode portions is c, and the wavelength corresponding to a lower limit frequency within a usage frequency band is λ₀.
6≦b/a≦11.5
c/λ₀≦0.25
−36.4×c/λ₀+11.5≦b/a

8. The wide-band antenna according to claim 4, wherein
the radiation devices are covered with a dielectric case.

9. The wide-band antenna according to claim 8, wherein
the radiation devices are formed from conductive patterns forming the first radiation device and the second radiation device which are formed on at least one of the surfaces of a dielectric substrate.

10. The wide-band antenna according to claim 9, wherein the following equation is satisfied, wherein the diameter of the outer conductor of the electric supply line is a, the distance between the outer edges of the two electrode portions is b, the longitudinal length of the electrode portions is c, and the wavelength corresponding to a lower limit frequency within a usage frequency band is λ₀.
b/a≦12
−33.3×c/λ₀+12≦b/a≦−100×c/λ₀+24

11. The wide-band antenna according to claim 1, wherein the following equation is satisfied, wherein the diameter of the outer conductor of the electric supply line is a, the distance between the outer edges of the two electrode portions is b, and a horizontal width of the electrode portions is w.
0.17≦2w/(b−a)≦0.95

12. A wide-band antenna comprising:
radiation devices including a first radiation device and a second radiation device; and
an electric supply line including a coaxial cable,
wherein the first radiation device is a conductor member with a conical shape connected to an inner core of the electric supply line,
the second radiation device is a conductor member being connected to an outer conductor of the electric supply line and including a radiation portion with a conical shape and a tubular-shaped conductor mounted to a bottom surface of the radiation portion such that the tubular-shaped conductor extends downwardly, and
the first radiation device and the second radiation device are placed such that the apexes of their conical shapes are opposed to each other, and the tubular-shaped conductor is placed such that a center axis of the tubular-shaped conductor is parallel to the electric supply line.

13. The wide-band antenna according to claim 12, wherein the following equation is satisfied, wherein a diameter of the outer conductor of the electric supply line is a, a distance between the outer edges of the two electrode portions is b, an axial length of the tubular-shaped conductor is c, and a wavelength corresponding to a lower limit frequency within a usage frequency band is λ₀.
6≦b/a≦9
c/λ₀≦0.25
−30×c/λ₀+9≦b/a

14. The wide-band antenna according to claim 12, wherein the following equation is satisfied, wherein the diameter of the outer conductor of the electric supply line is a, an outer diameter of the tubular-shaped conductor is b, and a radial thickness of the tubular-shaped conductor is w.
0.17≦2w/(b−a)≦0.95

15. An electronic apparatus comprising the wide-band antenna according to claim 1.

16. A transmission method which transmits information using the wide-band antenna according to claim 1.

17. The wide-band antenna according to claim 10, wherein the following equation is satisfied, wherein the diameter of the outer conductor of the electric supply line is a, the distance between the outer edges of the two electrode portions is b, and a horizontal width of the electrode portions is w.
0.17≦2w/(b−a)≦0.95

18. An electronic apparatus comprising the wide-band antenna according to claim 12.

19. A transmission method which transmits information using the wide-band antenna according to claim 12.
